(19) United States
(12) Patent Application Publication
(10) Pub. No.: US 2006/0177724 A1
(43) Pub. Date: Aug. 10, 2006

(54) Fuel cell

(76) Inventors: Nobuyasu Tajima, Ome-shi (JP); Eiichi Sakaue, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/349,427

(22) Filed: Feb. 7, 2006

(30) Foreign Application Priority Data
Feb. 8, 2005 (JP) 2005-032039

(51) Int. Cl. H01M 8/04

(52) U.S. Cl. 429/34

(57) ABSTRACT

According one embodiment, a fuel cell includes an electromotive section, a fuel tank, a mixing tank in which a fuel supplied from the fuel tank is mixed with water and an aqueous fuel solution to be supplied to the electromotive section is formed, an anode line through which the fuel is circulated between the electromotive section and the mixing tank, an air supply section which supplies air to the electromotive section, and a cathode line through which water obtained by condensing steam delivered from the electromotive section is guided to the mixing tank. The mixing tank has a water inlet, which is connected to the cathode line, extends at an angle to a vertical direction, and produces convection currents in the mixing tank, and a fuel inlet, which is connected to the fuel supply line and situated above the water inlet with respect to the vertical direction.

### CROSS-REFERENCE TO RELATED APPLICATIONS

This application is based upon and claims the benefit of priority from prior Japanese Patent Application No. 2005-032039, filed Feb. 8, 2005, the entire contents of which are incorporated herein by reference.

### BACKGROUND

1. Field

The present invention relates to a fuel cell used as a power source for an electronic device, etc.

2. Description of the Related Art

Presently, a secondary battery, e.g., a lithium ion battery, is mainly used as a power source for electronic devices, such as portable notebook personal computers (notebook PCs), mobile devices, etc. In recent years, high-output miniature fuel cells that require no charging are expected as novel power sources, based on a demand for increased power consumption and prolonged operating time that are required by enhanced functions of the electronic devices. Among various types of fuel cells, a direct methanol fuel cell (DMFC) that uses a methanol solution as its fuel can handle the fuel more easily and has a simpler system than fuel cells that use hydrogen as their fuel. Accordingly, the DMFC is noticed as a promising power source for the electronic devices.

As a fuel cell of this type, one that uses a dilution circulation system is proposed in, for example, Jpn. Pat. Appln. KOKAI Publication No. 2004-95376. In this system, a low-concentration aqueous methanol solution circulates. High-concentration methanol is resupplied to compensate for the consumption of methanol by power generation, while water that is produced by chemical reaction is recovered to make up for water consumption. To attain this, a mixing tank is provided in which an aqueous methanol solution is produced by mixing the supplied high-concentration methanol and the water. An electromotive section has an anode and a cathode such that power generation is achieved by chemical reaction as diluted methanol and air are supplied to the anode and cathode sides, respectively.

In order to continue power generation without hindrance, in the fuel cell constructed in this manner, the methanol concentration of the aqueous methanol solution that is supplied to the electromotive section must be kept within a given range. To attain this, the supplied methanol and water must be securely mixed with high efficiency in the mixing tank. Since methanol is higher in specific gravity than water, however, it easily collects at the bottom of the mixing tank, so that it cannot easily be uniformly mixed with water.

Further, a mixing mechanism having rotating blades may possibly be provided in the mixing tank to mix the methanol uniformly with water. In this case, however, the mechanism requires use of a driving source such as a motor, so that the fuel cell is inevitably increased in size and complicated in structure. Thus, the fuel cell entails higher power consumption, so that its proper function is degraded.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing a fuel cell according to a first embodiment of the invention;

FIG. 2 is an exemplary perspective view showing the fuel cell connected to a personal computer;

FIG. 3 is an exemplary system diagram mainly showing a configuration of a power generation section of the fuel cell;

FIG. 4 is an exemplary view schematically showing the power generation section of the fuel cell;

FIG. 5 is an exemplary diagram typically showing a cell structure of an electromotive section of the fuel cell;

FIG. 6 is an exemplary longitudinal sectional view showing a mixing tank of the fuel cell;

FIG. 7 is an exemplary cross-sectional view showing the mixing tank;

FIG. 8 is an exemplary longitudinal sectional view showing a mixing tank of a fuel cell according to a second embodiment of the invention; and

FIG. 9 is an exemplary longitudinal sectional view showing a mixing tank of a fuel cell according to a third embodiment of the invention.

### DETAILED DESCRIPTION

Various embodiments according to the invention will be described hereinafter with reference to the accompanying drawings. In general, according to one embodiment of the invention, a fuel cell comprises: an electromotive section which generates electric power through a chemical reaction; a fuel tank which contains a fuel; a mixing tank in which the fuel supplied from the fuel tank is mixed with water and an aqueous fuel solution to be supplied to the electromotive section is formed; an anode line through which the fuel is circulated between the electromotive section and the mixing tank; an air supply section which supplies air to the electromotive section; and a cathode line through which water obtained by condensing steam delivered from the electromotive section is guided to the mixing tank. The mixing tank has a water inlet, which is connected to the cathode line, extends at an angle to a vertical direction, and produces convection currents in the mixing tank, and a fuel inlet, which is connected to the fuel supply line and situated above the water inlet with respect to the vertical direction.

A fuel cell according to a first embodiment of this invention will now be described in detail with reference to the accompanying drawings.

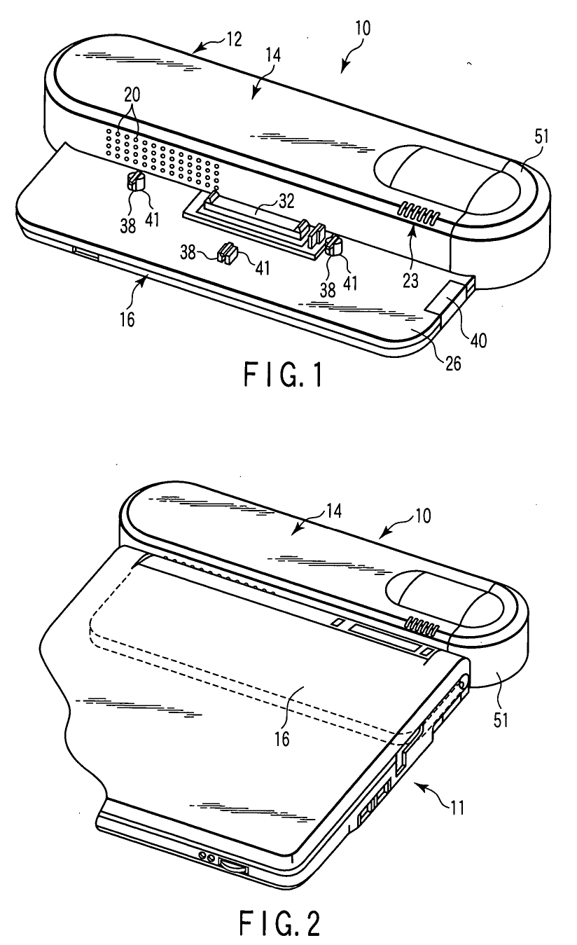

As shown in FIGS. 1 and 2, a fuel cell 10 is constructed as a DMFC that uses methanol as a liquid fuel and is usable as a power source for an electronic device, such as a personal computer 11.

The fuel cell 10 is provided with a case 12. The case 12 has a horizontally extending body 14 substantially in the form of a prism and a bearer portion 16 that extends from the body. The bearer portion 16, which is in the form of a flat rectangle, can carry a rear part of the computer 11. As described later, the body 14 contains therein a fuel tank, electromotive section, mixing tank, etc. A lock mechanism for locking the computer 11 and the like are located on the bearer portion 16.

As shown in FIG. 1, a connector 32 for connection with the personal computer 11 is provided on the upper surface of the bearer portion 16. A connector (not shown) for connection with the connector 32 of the fuel cell 10 is provided on a rear part of, for example, the bottom surface of the computer 11 and is connected mechanically and electrically to the connector 32. Positioning projections 41 and hooks 38 that constitute the lock mechanism are provided on three spots of the bearer portion 16. The positioning projections 41 and the hooks 38 engage the rear part of the bottom surface of the computer 11, thereby positioning and holding the computer 11 on the bearer portion 16. Further, the bearer portion 16 is provided with an eject button 40 that is used to unlock the lock mechanism in disengaging the computer 11 from the fuel cell 10. The bearer portion 16 has therein a control section for controlling the operation of a power generation section, which will be described later.

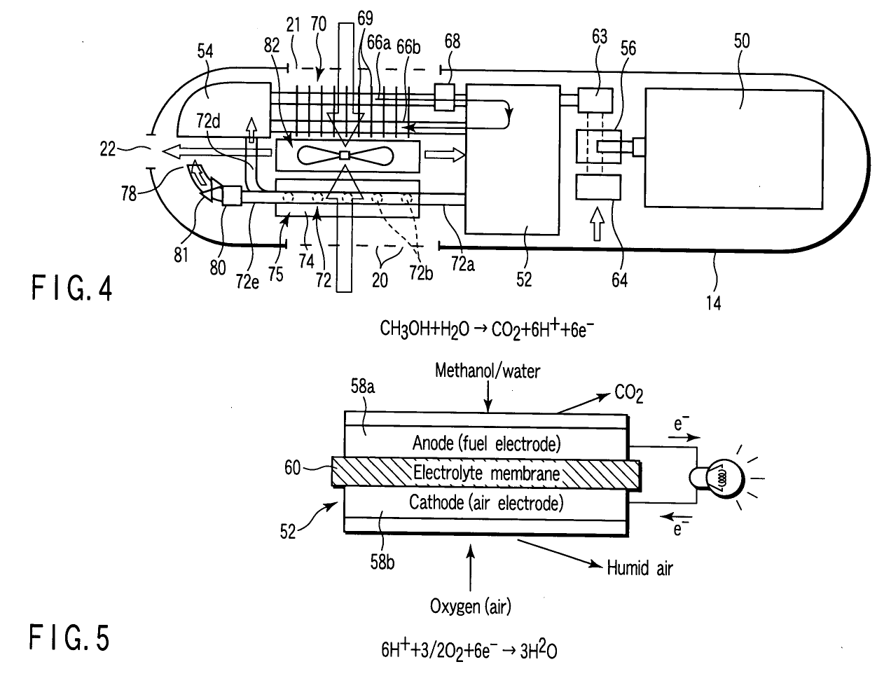

As shown in FIGS. 1 and 4, a wall portion of the body 14 is formed with a number of vents 20, 21, and 22. A plurality of indicators 23 for indicating the operation states of the fuel cell are disposed at the front end portion of the body 14. As described later, a fuel tank 50 that constitutes the power generation section is constructed as a removable fuel cartridge. One side portion of the body 14 is formed as a cover 51 that can be removed when the fuel tank 50 is detached.

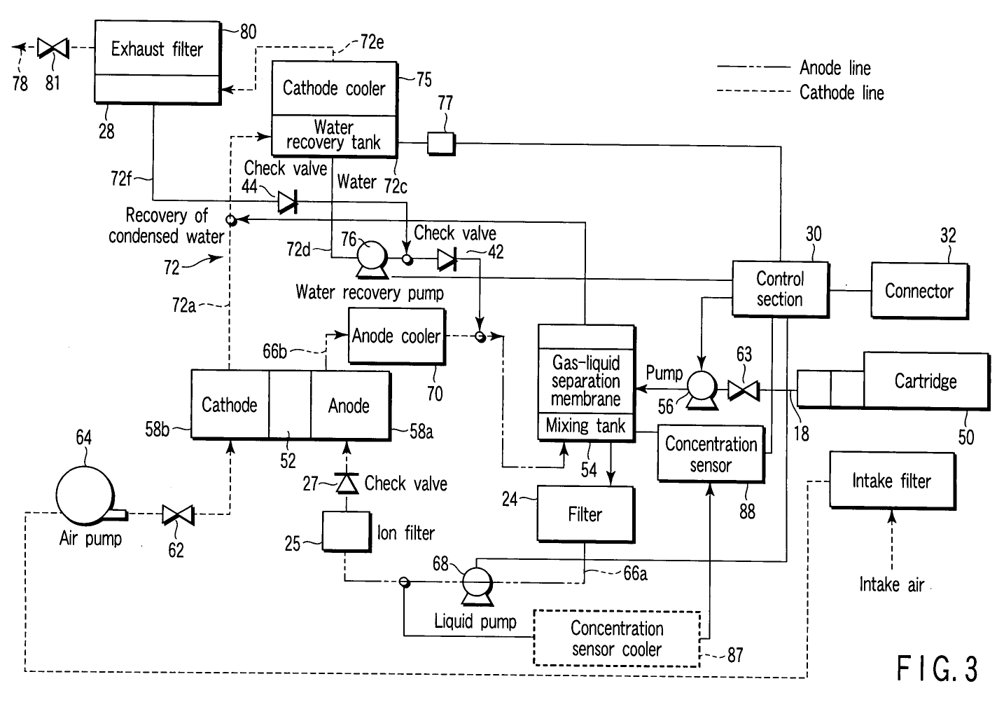

The configuration of the power generation section will now be described in detail. FIG. 3 is a system diagram mainly showing the power generation section, especially details of an electromotive section 52 formed of a DMFC stack and accessories around it. As shown in FIGS. 3 and 4, the power generation section comprises the fuel tank 50, the electromotive section 52, a mixing tank 54, an anode cooler 70, and a cathode cooler 75. The fuel tank 50 is provided in one side portion of the body 14. The electromotive section 52 is located in the central part of the body 14 and performs power generation through a chemical reaction. The mixing tank 54 is disposed between the electromotive section and the fuel tank. The coolers 70 and 75 are arranged in the other side portion of the body. The fuel tank 50 contains high-concentration methanol for use as a liquid fuel. The tank 50 is formed as a cartridge that can be attached to and detached from the body 14.

The fuel tank 50 is connected to the mixing tank 54 by a fuel supply line 18, which is provided with a first liquid pump 56, which feeds a fuel from the fuel tank into the mixing tank, and a solenoid valve 63. As shown in FIG. 5, the electromotive section 52 is formed by stacking cells in layers. Each cell is formed of an anode (fuel electrode) 58a, a cathode (air electrode) 58b, and an electrolyte membrane 60 sandwiched between the electrodes. A large number of cooling fins 61 are arranged around the electromotive section 52.

As shown in FIGS. 3 and 4, the body 14 contains therein an air pump 64, which supplies air to the cathode 58b of the electromotive section 52 through an air valve 62. The air pump 64 constitutes an air supply section. A fuel supply pipe 66a and a fuel recovery pipe 66b are connected between the electromotive section 52 and the mixing tank 54, and form an anode line through which the fuel is circulated between the anode 58a of the electromotive section and the tank 54. The fuel supply pipe 66a is connected with a filter 24, a second liquid pump 68, an ion filter 25, and a check valve 27. The pump 68 delivers the fuel from the mixing tank 54 to the electromotive section 52.

An exhaust pipe 72 is connected to the electromotive section 52 and forms a cathode line through which air and products of power generation are discharged from the cathode 58b. The cathode line has a first line 72a extending from the electromotive section 52, a plurality of branch lines 72b, a reservoir portion (water recovery tank) 72c, a first recovery line 72d, and a second line 72e. The branch lines 72b diverge from the first line 72a and extend individually at angles to the horizontal direction. The reservoir portion 72c communicates with the first line 72a and the respective lower ends of the branch lines 72b and stores water discharged from the first line and water condensed in the branch lines. The first recovery line 72d guides the water stored in the reservoir portion 72c into the mixing tank 54. The second line 72e opens into the respective upper ends of the branch lines 72b. In the present embodiment, the branch lines 72b individually extend in the vertical direction. Further, the first recovery line 72d communicates with the fuel recovery pipe 66b between the anode cooler 70 and the mixing tank 54, and is connected to the mixing tank by the fuel recovery line.

The first recovery line 72d is provided with a water recovery pump 76, which supplies the water in the reservoir portion 72c to the mixing tank 54. Further, the reservoir portion 72c contains therein a water level sensor 77 for detecting the level of the water stored in the reservoir portion.

A number of horizontally extending radiator fins 74 are mounted around the exhaust pipe 72 that defines the branch lines 72b, thus constituting a cathode cooler 75. The cathode cooler 75 that includes the branch lines 72b is opposed to the anode cooler 70 with a gap between the two. As shown in FIG. 4, the second line 72e extends substantially horizontally and is provided with an exhaust port 78 that opens toward a vent 22 in the body 14. The vents 20 formed in the front wall of the body 14 face to the cathode cooler 75.

In the second line 72e, an exhaust filter 80 and an exhaust valve 81 are located near the exhaust port 78. The exhaust filter 80 is formed of, for example, a metal catalyst or the like and serves to remove toxic substances such as methanol in the air that is discharged through the cathode line. A water recovery portion 28 is provided vertically under the exhaust filter 80 and communicates with the second line 72e. Further, the cathode line has a second recovery line 72f through which the water recovered in the water recovery portion 28 is led to the first recovery line 72d. The second recovery line 72f is connected to the first recovery line 72d between the water recovery pump 76 and the mixing tank 54.

Between the water recovery pump 76 and the mixing tank 54, the first recovery line 72d is provided with a check valve 42 that restrains the water from flowing back from the mixing tank 54 toward the pump 76. Between the check valve 42 and the water recovery portion 28, the second recovery line 72f is provided with a check valve 44 that restrains the water from flowing back from the pump 76 to the water recovery portion 28.

In the body 14, as shown in FIG. 4, a cooling fan 82, a centrifugal fan, is located between the anode cooler 70 and the cathode cooler 75 so as to face these coolers. The fan 82 is arranged so that the rotation axis of the vanes extends in the horizontal direction and to across perpendicularly to the anode and cathode coolers 70 and 75.

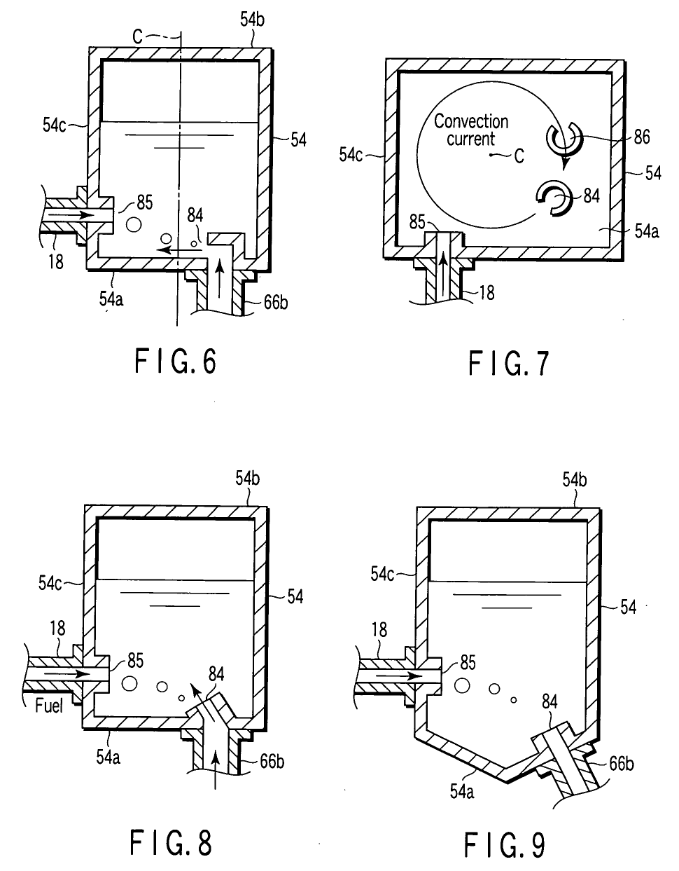

As shown in FIGS. 6 and 7, the mixing tank 54 is substantially in the form of a prism, and has a bottom wall 54a and a top wall 54b, which extend horizontally, and vertically extending sidewalls 54c. A water inlet 84 is formed in the bottom wall 54a and is connected with the fuel recovery pipe 66b that constitutes a part of the cathode line. As described later, the water inlet 84 is supplied with the recovered water, carbon dioxide, and fuel through the fuel recovery pipe 66b. The water inlet 84 extends at an angle to the vertical direction so that convection currents are produced in the mixing tank 54. In the present embodiment, the water inlet 84 opens in the horizontal direction.

A fuel inlet 85 is formed in one of the sidewalls 54c of the mixing tank 54 so as to be situated above the water inlet 84 with respect to the vertical direction. The fuel supply line 18 is connected to the fuel inlet 85 and the high-concentration methanol is supplied from the fuel tank 50 to the inlet 85 through the fuel supply line 18. The fuel inlet 85 opens substantially in the horizontal direction.

The mixing tank 54 has a vertically extending central axis C and the water inlet 84 is located eccentrically relative to the central axis C. The water inlet 84 opens toward the fuel inlet 85 so that the convection currents formed in the mixing tank 54 by the water, carbon dioxide, and fuel introduced through the water inlet run against the methanol that is introduced through the fuel inlet 85 into the mixing tank.

The bottom wall of the mixing tank 54 is formed having a fuel supply port 86 through which the diluted methanol in the mixing tank is delivered, and the fuel supply pipe 66a is connected to the port 86. The fuel supply port 86 is located eccentrically relative to the central axis C of the mixing tank 54 and opens in a direction such that it faces the convection currents in the mixing tank.

The power generation section is provided with a concentration sensor 88 for detecting the concentration of the fuel stored in the mixing tank 54 and a fuel cooling section 87 for cooling the fuel delivered to the concentration sensor 87.

As shown in FIG. 3, the first and second liquid pumps 56 and 68, air pump 64, water recovery pump 76, air valve 62, exhaust valve 81, and cooling fans 82, which constitute the power generation section, are connected electrically to a control section 30 and controlled by the control section. Further, the water level sensor 77 and the concentration sensor 88 are connected to the control section 30 and individually output detection signals to the control section. Wires (not shown) connecting the electric pars and the sensors with the control section 30 are drawn from the body 14 into the bearer portion 16.

If the fuel cell 10 constructed in this manner is used as the power source for the personal computer 11, the rear end portion of the computer is first placed on the bearer portion 16 of the fuel cell, locked in a predetermined position, and connected electrically to the fuel cell. In this state, a switch (not shown) is turned on to start power generation in the fuel cell 10. In this case, high-concentration methanol is supplied from the fuel tank 50 to the mixing tank 54 by the first liquid pump 56 and mixed with water as a solvent refluxed from the electromotive section 52, whereby it is diluted to a given concentration. The aqueous methanol solution diluted in the mixing tank 54 is supplied through the anode line to the anode 58a of the electromotive section 52 by the second liquid pump 68. On the other hand, air is supplied to the cathode 58b of the electromotive section 52 by the air pump 64. As shown in FIG. 5, the supplied methanol and water chemically react with each other in the electrolyte membrane 60 between the anode 58a and the cathode 58b, whereupon electric power is generated between the anode and the cathode. The power generated in the electromotive section 52 is supplied to personal computer 11 through the control section 30 and the connector 32.

With the progress of the power generation reaction, carbon dioxide and water are produced as reaction products on the sides of the anode 58a and the cathode 58b, respectively, in the electromotive section 52. The carbon dioxide produced on the anode side and an unaffected portion of the methanol are delivered to the anode line, cooled through the anode cooler 70, and then refluxed into the mixing tank 54. The carbon dioxide is gasified in the mixing tank 54 and discharged to the outside through the cathode cooler 75, exhaust valve 81, and finally, the exhaust port 78.

Most of the water produced on the side of the cathode 58b is reduced to steam, which is discharged together with air into the cathode line. The discharged water and steam pass through the first line 72a, and the water is fed into the reservoir portion 72c. The steam and air flow upward through the branch lines 72b to the second line 72e. As this is done, the steam that flows through the branch lines 72b is cooled and condensed by the cathode cooler 75. The water produced by the condensation flows downward in the branch lines 72b by gravity and is recovered into the reservoir portion 72c. The water recovered in the reservoir portion 72c is delivered to the mixing tank 54 by the water recovery pump 76, mixed with the methanol, and supplied again to the electromotive section 52.

Some of the air and steam delivered to the second line 72e is fed into the water recovery portion 28. As this is done, the steam is condensed into water in the second line 72e, and the resulting water is recovered into the water recovery portion 28. The air and the methanol splashed in the air are delivered to the exhaust filter 80, whereupon the methanol is removed by the filter. The air passes through the exhaust valve 81 and is discharged into the body 14 through the exhaust port 78, and moreover, to the outside through the vents 20 of the body. The carbon dioxide discharged from the anode side of the electromotive section 52 passes through the second line 72e and is discharged into the body 14 through the exhaust port 78, and moreover, to the outside through the vent 22 of the body.

During the operation of the fuel cell 10, the cooling fan 82 is driven so that the outside air is introduced into the body 14 through the vents 20 and 21 of the body. As shown in FIG. 4, the outside air introduced into the body 14 through the vents 20 and the air in the body 14 pass around the fuel cooling section 87 and the anode cooler 70, thereby cooling them, and are then sucked in by the cooling fan 82. The outside air introduced into the body 14 through the vent 21 and the air in the body 14 pass around the cathode cooler 75, thereby cooling it, and are then sucked in by the cooling fan 82.

The air drawn in by the cooling fan 82 is discharged through an exhaust port (not shown) of the cooling fan into the body 14, passes through the body 14, and is then discharged to the outside through the vent of the body. As this is done, the air discharged through the cooling fan 82 is mixed with air and carbon dioxide that are discharged through the exhaust port 78 of the cathode line, and the resulting mixture is discharged through the vent to the outside of the body. Further, the air discharged from the cooling fan 82 cools the electromotive section 52 and its surroundings and is then discharged to the outside of the body 14.

The concentration of the methanol in the mixing tank 54 is detected by the concentration sensor 88. Based on the detected concentration, the control section 30 actuates the water recovery pump 76 to supply the water in the reservoir portion 72c to the mixing tank 54, thereby keeping the methanol concentration constant. Further, the amount of water recovered in the cathode line, that is, the amount of condensed steam, is adjusted by controlling the cooling capacity of the cathode cooler 75, depending on the level of the water recovered in the reservoir portion 72c. In this case, the cooling capacity of the cathode cooler 75 is adjusted by controlling the driving voltage of the cooling fan 82 according to the water level detected by the water level sensor 77. By doing this, the amount of water recovery is controlled.

As the water is recovered, the water recovery pump 76 is rotated forward by the control section 30. Thereupon, the check valve 42 opens, and the check valve 44 closes. The water in the reservoir portion 72c is delivered to the mixing tank 54 via the first recovery line 72d and the check valve 42.

The control section 30 drives the water recovery pump 76 for reverse rotation for a given time at every given operating period, whereupon the water collected in the water recovery portion 28 is recovered into the reservoir portion 72c. Thus, when the water recovery pump 76 is reversed, the check valve 44 opens, and the check valve 42 closes. The water collected in the water recovery portion 28 and the water produced by condensation in the second line 72e are recovered into the reservoir portion 72c through the second recovery line 72f, check valve 44, and the first recovery line 72d. Thereafter, the recovered water is supplied to the mixing tank 54 and used for the dilution of the methanol.

In the mixing tank 54, as shown in FIGS. 6 and 7, the carbon dioxide produced on the side of the anode 58a, an unaffected portion of the methanol, and the water recovered from the reservoir portion 72c through the anode line pass through the fuel recovery pipe 66b and are fed through the water inlet 84 into the mixing tank 54. The carbon dioxide, methanol, and water introduced into the mixing tank 54 produce eddy convection currents that flow around the central axis C from the side of the bottom wall 54a toward the top wall 54b in the mixing tank. The high-concentration methanol that is fed through the fuel supply line 18 and introduced into the mixing tank 54 through the fuel inlet 85 runs against the convection currents in the tank 54. Thereupon, it is stirred and mixed with the water and fuel introduced through the water inlet 84. Thus, the aqueous methanol solution in the mixing tank 54 can be efficiently mixed and kept at a uniform concentration.

The aqueous methanol solution mixed in the mixing tank 54 is supplied to the fuel supply pipe 66a through the fuel supply port 86 in the bottom wall 54a of the mixing tank. As this is done, the methanol solution can be smoothly delivered to the fuel supply port 86, since the port 86 opens opposite the convection currents produced in the mixing tank.

According to the fuel cell 10 constructed in this manner, the high-concentration methanol and water can be efficiently stirred and uniformly mixed in the mixing tank 54. In this case, the interior of the mixing tank 54 can be agitated to mix the methanol and water uniformly by utilizing the convection currents in the mixing tank without providing any stirring mechanism that has stirring blades. Accordingly, the constant-concentration aqueous methanol solution can be supplied without increasing the size of the fuel cell, complicating the structure, or increasing the power consumption. Thus, a fuel cell can be realized for stable power generation.

In the embodiment described above, the water inlet 84 of the mixing tank 54 opens in the horizontal direction. However, the water inlet 84 is expected only to extend at an angle to the vertical direction. In a fuel cell according to a second embodiment of this invention, as shown in FIG. 8, a bottom wall 54a of a mixing tank 54 extends horizontally, and a water inlet 84 formed in the bottom wall 54a extends at an angle to the vertical and horizontal directions.

In a fuel cell according to a third embodiment this invention, as shown in FIG. 9, a bottom wall 54a of a mixing tank 54 extends at an angle to the horizontal direction. A water inlet 84 formed in the bottom wall 54a extends at an angle to the vertical and horizontal directions.

Since the other configurations of the fuel cells of the second and third embodiments are the same as those of the first embodiment, like portions are designated by like reference numerals, and a detailed description thereof is omitted. The second and third embodiments can provide the same functions and effects as those of the first embodiment.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

According to each of the embodiments described above, the mixing tank 54 is substantially in the form of a prism. However, it may be formed having any other shape, such as a cylindrical shape. Although the water inlet of the mixing tank is situated eccentrically relative to the central axis of the tank, it may alternatively be located on the central axis provided that convection currents can be produced.

Although the power generation section is composed of the fuel tank 50, electromotive section 52, mixing tank 54, anode cooler 70, cathode cooler 75, and mixing tank 54 that are arranged in the order named, this order of arrangement may be changed variously as required. The fuel cell according to this invention may be also used as a power source for any other electronic devices than the personal computer described herein, such as mobile devices, portable terminals, etc. The type of fuel cell is not limited to the DMFC but may be any other type, such as a PEFC (polymer electrolyte fuel cell).

What is claimed is:

1. A fuel cell comprising:
an electromotive section which generates electric power through a chemical reaction;
a fuel tank which contains a fuel;
a mixing tank in which the fuel supplied from the fuel tank is mixed with water and an aqueous fuel solution to be supplied to the electromotive section is formed;
an anode line through which the fuel is circulated between the electromotive section and the mixing tank;
an air supply section which supplies air to the electromotive section; and
a cathode line through which water obtained by condensing steam delivered from the electromotive section is guided to the mixing tank,
the mixing tank having a water inlet, which is connected to the cathode line, extends at an angle to a vertical direction, and produces convection currents in the mixing tank, and a fuel inlet, which is connected to the fuel supply line and situated above the water inlet with respect to the vertical direction.

2. The fuel cell according to claim 1, wherein the water inlet opens toward the fuel inlet.

3. The fuel cell according to claim 1, wherein the mixing tank has a central axis and the water inlet is located eccentrically relative to the central axis.

4. The fuel cell according to claim 1, wherein the mixing tank has a bottom wall extending in a horizontal direction, the water inlet being provided in the bottom wall.

5. The fuel cell according to claim 1, wherein the mixing tank has a bottom wall extending at an angle to a horizontal direction, the water inlet being provided in the bottom wall.

6. The fuel cell according to claim 1, wherein the mixing tank has a fuel supply port which is connected to the anode line and through which the aqueous methanol solution is delivered, the fuel supply port opening opposite the convection currents produced in the mixing tank.

7. A fuel cell comprising:
an electromotive section which generates electric power through a chemical reaction;
a fuel tank which contains a fuel;
a mixing tank in which the fuel supplied from the fuel tank is mixed with water and an aqueous fuel solution to be supplied to the electromotive section is formed;
an anode line through which the fuel is circulated between the electromotive section and the mixing tank;
an air supply section which supplies air to the electromotive section; and
a cathode line through which water obtained by condensing steam delivered from the electromotive section is guided to the mixing tank,
the mixing tank having a fuel inlet connected to the fuel supply line and a water inlet which is connected to the cathode line and through which water flows in toward the fuel inlet.
